(19) United States
(12) Patent Application Publication
(10) Pub. No.: US 2019/0217497 A1
(43) Pub. Date: Jul. 18, 2019

(54) Utility Chain For Cutting Ductile Materials

(71) Applicant: Cosmos Manufacturing, Inc., South Chicago Heights, IL (US)

(72) Inventors: John Michelon, Crete, IL (US); Wally Casey, Frankfort, IL (US); Jordan Szafranski, Palos Park, IL (US); Mike Jemilo, Frankfort, IL (US)

(21) Appl. No.: 16/247,557

(22) Filed: Jan. 14, 2019

Related U.S. Application Data
(60) Provisional application No. 62/616,792, filed on Jan. 12, 2018.

(51) Int. Cl. B27B 33/14

(52) U.S. Cl. CPC B27B 33/142; B26D 1/0006

(57) ABSTRACT

A utility chain for cutting ductile materials includes a plurality of cutting links. Each of the cutting links includes a sintered cutting segment, a first side plate, and a second side plate. Each of the sintered cutting segments includes abrading particles embedded in a bonding matrix. The utility chain further includes a plurality of drive links, each of which is connected to a cutting link, and a plurality of connectors, each of which maintains the attachment of a cutting link to a drive link.

### CROSS-REFERENCE TO RELATED APPLICATION

This application claims priority benefits from U.S. provisional patent application Ser. No. 62/616,792 filed on Jan. 12, 2018, entitled “Utility Chain For Cutting Ductile Materials”. The '792 application is hereby incorporated by reference herein in its entirety.

### FIELD OF THE INVENTION

The present invention relates to cutting devices. More specifically, the invention relates to a utility chain utilized in a chainsaw for cutting utility pipes.

Chainsaws are essential tools utilized in construction, masonry, carpentry, logging and other industries to cut through a variety of materials including concrete, cinder blocks, brick, asphalt, stone, iron pipes and wood.

The major components of a gas chainsaw can include an engine, a drive mechanism such as a centrifugal clutch and sprocket, a tensioner, a guide bar and/or a utility chain. Saws that utilize a hydraulic system can include a fluid reservoir, fluid circuit, hydraulic pump and a hydraulic motor or cylinder. The engine or motor supplies power to the drive mechanism to facilitate movement of the chain around the guide bar.

Common chainsaw utility chains comprise alternating right-handed and left-handed cutting links, drive links and bumper spacer links in the following repeating pattern: right-handed cutting link, drive link, bumper spacer link, drive link, left-handed cutting link, drive link, bumper spacer link, drive link, and right handed cutting link. The cutting segments of the cutting links are responsible for cutting through material. Drive links serve to engage the drive sprocket to provide a driving force and guide the movement of the chain around the guide bar. Bumper spacer links reside between the cutting link segments to provide impact protection to the cutting link segments.

Cutting segments of diamond saw blades are designed to cut through a variety of materials including concrete, asphalt, granite, terrazzo and ductile iron pipes. The cutting segments of the blade are made of two components which constitute the sintered cutting segment: diamond crystals and a metal bonding matrix. The diamond crystals function to grind through the material to be cut while the metal bonding matrix holds the diamonds in place.

The composition of the bonding matrix is chosen to achieve an appropriate wear rate based on the intended cutting medium. A bonding matrix should secure diamond crystals for the length of time in which the exposed diamonds are sharp enough to grind through a desired material. As the diamonds begin to fracture, controlled erosion of the bonding matrix releases the used diamonds to expose the next layer of in-tact diamond crystals.

Depending on the nature of the cutting medium and type of cutting segment, bumper spacer links can limit the effectiveness of the cutting link segment. For abrasive materials such as concrete, the bumper spacer links wear down due to repeated exposure to the cutting medium. Therefore, as the height of the cutting link decreases with use, the height of the bumper spacer link is proportionally decreased. This allows for newly exposed diamond crystals to make sufficient contact with the material to be cut.

For less abrasive materials such as iron pipe, the bumper spacer links fail to wear down over time while a sintered segment on the cutting link undergoes controlled erosion. Eventually, the cutting segments are worn down to the same height as the bumper spacer link. This prevents the diamond crystals of the cutting segment from fully engaging the pipe rendering the utility chain nonfunctional.

One potential solution for a utility chain for cutting iron pipe is the use of a brazed, rather than a sintered cutting segment. In a brazed cutting segment, diamond crystals are brazed to the surface of a chain link intended to serve as a cutting link. However, the disadvantage of brazed cutting segments is that the diamond crystals begin to fracture and break off with use, decreasing performance over the life of the utility chain. By contrast, sintered segments are designed to wear with use and expose new diamond crystals resulting in consistent performance over the life of the utility chain.

A utility chain without bumper spacer links that employs a sintered cutting segment would be beneficial for the cutting of ductile materials, including iron pipe.

### SUMMARY OF THE INVENTION

Shortcomings of existing utility chains are overcome by a utility chain comprising a plurality of cutting links, in which each of the cutting links comprises a sintered cutting segment, a first side plate and a second side plate. Each of the sintered cutting segments comprises abrading particles embedded in a bonding matrix. The utility chain further comprises a plurality of drive links, each of which is connected to a cutting link, and a plurality of connectors, each of which maintains the attachment of a cutting link to a drive link.

In some embodiments, each of the cutting segments can be layered by sintering.

In some embodiments, the abrading particle concentration in the outer layers of each cutting segment can be greater than the abrading particle or diamond concentration in the inner layer of each cutting segment.

In some preferred embodiments, each of the abrading particles comprises diamond crystals. In some embodiments, the diamond concentration in the outer layers of each cutting segment can be preferably approximately 20 CON and the diamond concentration in the inner layer of each cutting segment can be preferably approximately 12 CON. In some embodiments, the diamond grit size can be preferably 30-40 mesh.

In some embodiments, each of the cutting segments is connected to the first side plate and the second side plate via laser welding.

In some embodiments, the connectors are rivets.

In some embodiments, a closed gap length is defined by the distance between a front end of a first layered cutting segment and a back end of second layered cutting segment.

In some embodiments the closed gap length is less than 0.35 cm.

In some embodiments, a utility chain for cutting ductile materials can include a plurality of cutting links, a plurality of drive links, plurality of connectors, and/or a closed gap length wherein said closed gap length is the distance between a front end of a first layered cutting segment and a back end of second layered cutting segment.

In some embodiments, the cutting links includes a layered cutting segment, a first side plate, and a second side plate.

In some embodiments, the layered cutting segments includes a plurality of abrading particles embedded in a bonding matrix.

In some embodiments, the connectors help maintain the attachment of the cutting links to the drive link.

In some embodiments, the closed gap length is less than 0.35 cm.

In some embodiments, the layered cutting segments is layered by sintering.

In some embodiments, the concentration of the plurality of abrading particles in an outer layer of each of the layered cutting segments is greater than the concentration of said plurality of abrading particles in an inner layer of each of said layered cutting segments.

In some embodiments, the plurality of abrading particles comprises diamond crystals. In some embodiments, the grit size of the diamond crystals is approximately 30-40 mesh. In some embodiments, the concentration of diamond crystals in an outer layer of each of the layered cutting segments is approximately 20 CON and the concentration of diamond crystals in an inner layer of each of the layered cutting segments is approximately 12 CON by weight.

In some embodiments, the layered cutting segments are connected to said first side plate and said second side plate by laser welding.

In some embodiments, each of the plurality of connectors is a rivets.

In some embodiments, the top surface of each of the layered cutting segments comprises a first surface notch and a second surface notch formed therein. In some embodiments, the first surface notch has a vertex angle of approximately 120°. In some embodiments, the second surface notch has a vertex angle of approximately 120°.

In some embodiments, the layered cutting segments have a length in the range of approximately 0.781 inch-0.793 inch (1.98 cm-2.01 cm).

In some embodiments, the length of each of the layered cutting segments defines a gap length in the range of approximately 0.119 inch-0.139 inch (0.30 cm-0.35 cm).

In some embodiments, each of the plurality of cutting links has a length in the range of approximately 0.912 inch-0.924 inch (2.32 cm-2.35 cm).

In some embodiments, the pitch of the utility chain is in the range of 0.456 inch-0.462 inch (1.16 cm-1.17 cm).

In some embodiments, the inner layer comprises a plurality of inner layers.

### BRIEF DESCRIPTION OF THE DRAWINGS

FIG. 1 is an exploded perspective view of a utility chain cutter with diamond crystals embedded in lateral layers in the cutting segment.

FIG. 2A is a perspective view of the outward facing surface of a side plate.

FIG. 2B is a perspective view of the inward facing surface of a side plate.

FIG. 2C is a front view of a side plate.

FIG. 2D is a top view of a side plate.

FIG. 3A is a side view of drive link.

FIG. 3B is a perspective view of a drive link.

FIG. 3C is a front view of a drive link.

FIG. 3D is a top view of a drive link.

FIG. 4A is a side view of a cutting segment with diamond crystals embedded in lateral layers in the cutting segment.

FIG. 4B is a perspective view of a cutting segment with diamond crystals embedded in lateral layers in the cutting segment.

FIG. 4C is a top view of a cutting segment with diamond crystals embedded in lateral layers in the cutting segment.

FIG. 4D is a front view of a cutting segment with diamond crystals embedded in lateral layers in the cutting segment.

FIG. 5 is a side view of an assembled utility chain.

FIG. 6 is a front view of an assembled utility chain.

### DETAILED DESCRIPTION OF ILLUSTRATIVE EMBODIMENT(S)

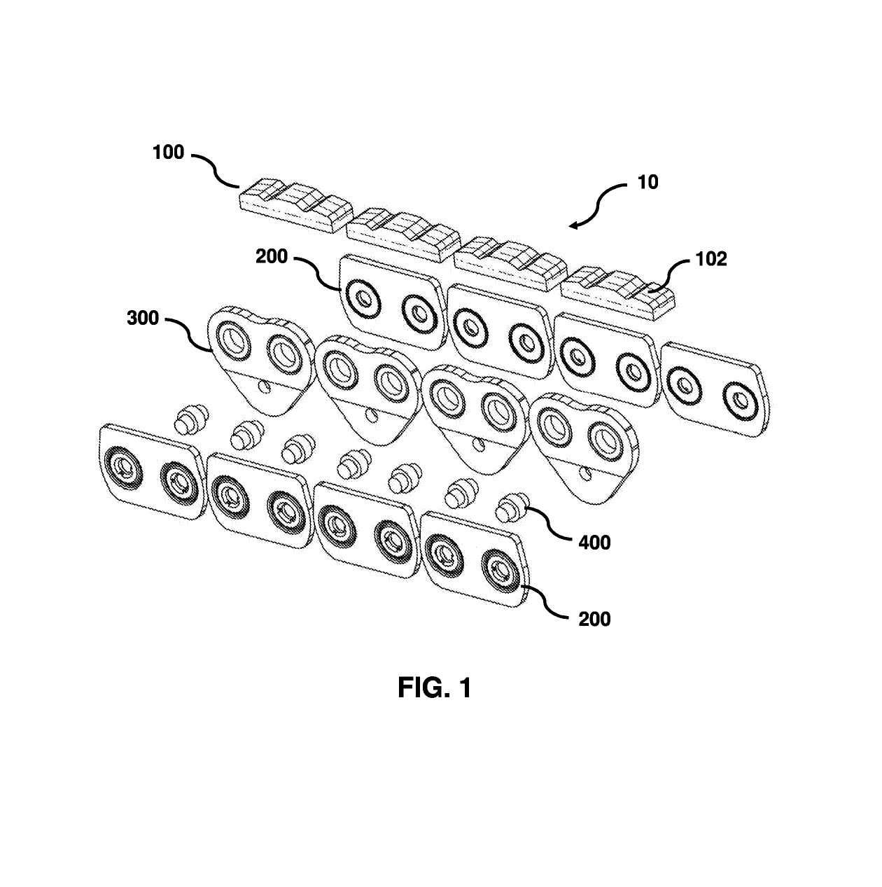

Turning to FIG. 1, utility chain 10 can comprise cutting segments 100, side plates 200, drive links 300 and rivets 400. In some embodiments, such as the one shown in FIG. 1, utility chain 10 lacks bumper spacer links which are common in sintered segment utility chains used to cut concrete. In some embodiments, such as when utility chain 10 is used to cut pipe with concrete liners, the lack of bumper spacer links allows cutting segments 100 of utility chain 10 to cut and wear at a consistent rate during the lifespan of utility chain 10. FIG. 1 shows utility chain 10 in which segment 100 has embedded diamond crystals in lateral layers 102.

In some embodiments, utility chain 10 can be utilized in a chainsaw having a body containing a motor and a guide bar extending from the body. In some embodiments, the guide bar can include a pair of rails with a groove between the rails. In some embodiments, the guide bar can include a nose sprocket.

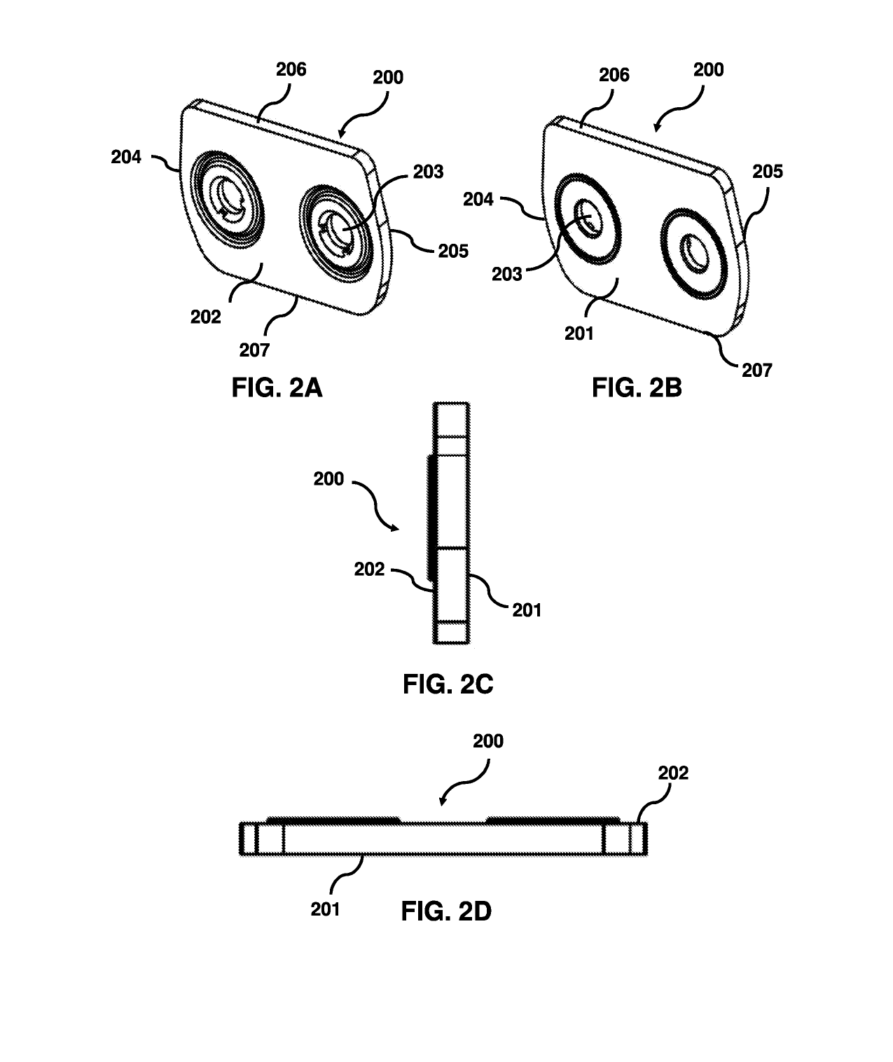

Referring to FIGS. 2A-2D, each side plate 200 comprises an inner surface 201 and an outer surface 202. In some embodiments, side plate 200 can be formed from materials such as various grades of steel or alloy steel. In some embodiments, side plate 200 can be formed from materials with increased tensile strength such as titanium or titanium alloy. Bottom surface 207 of side plate 200 can ride on the rails of the guide bar when utility chain 10 is used in a chainsaw. In some embodiments, side plate 200 can be coated in titanium or other suitable materials.

In some embodiments, side link 200 contains two openings 203 for assembly of utility chain 10. In some embodiments, opening(s) 203 can be rivet holes to connect each side link to adjacent links.

In some embodiments, such as the one shown, the side surfaces of side plate 200 are defined by side curve 204 and side curve 205. In some embodiments, side curve 204 and side curve 205 have the same degree of curvature.

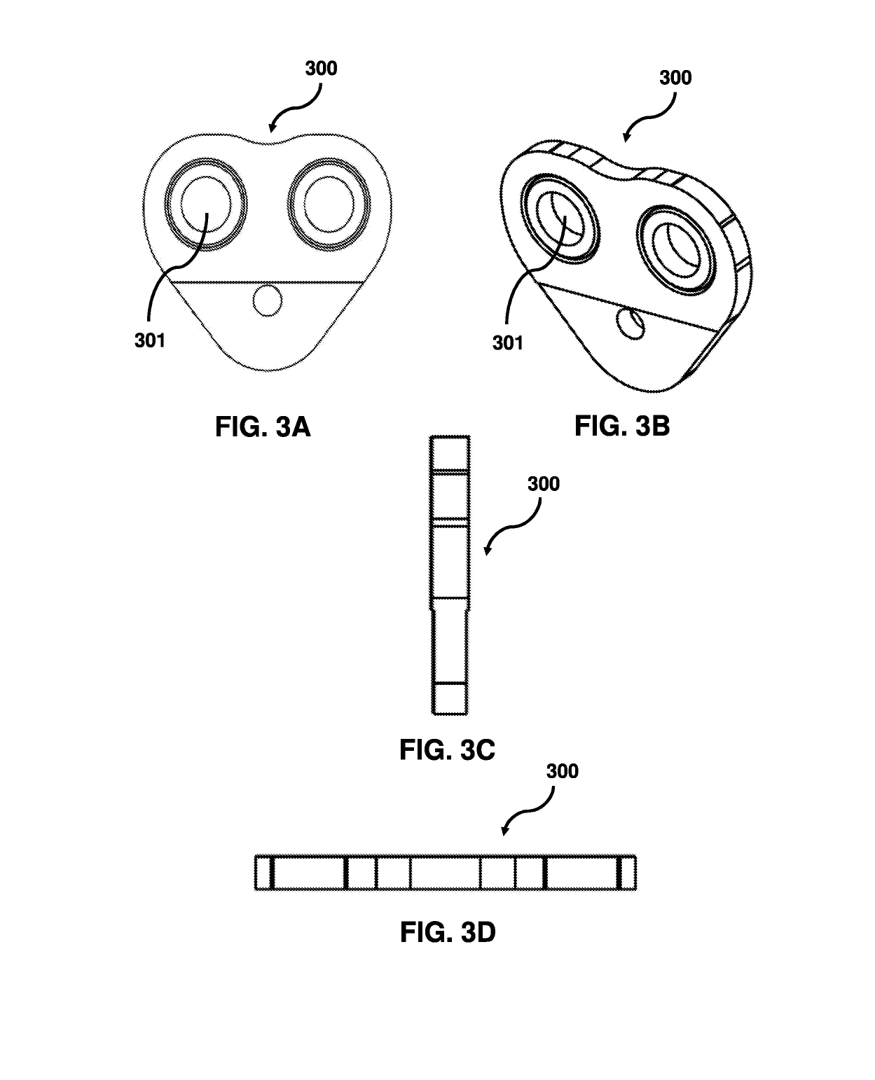

Referring to FIGS. 3A-3D, each drive link 300 contains two openings 301 for assembly of utility chain 10. In some embodiments, opening(s) 301 can be rivet holes to connect each drive link to adjacent links. In some embodiments, drive link 300 can be formed from materials such as various grades of steel or alloy steel. In some embodiments, drive link 300 is formed from materials with increased tensile strength such as titanium or titanium alloys. In some embodiments, drive link 300 can be coated in titanium or other suitable materials.

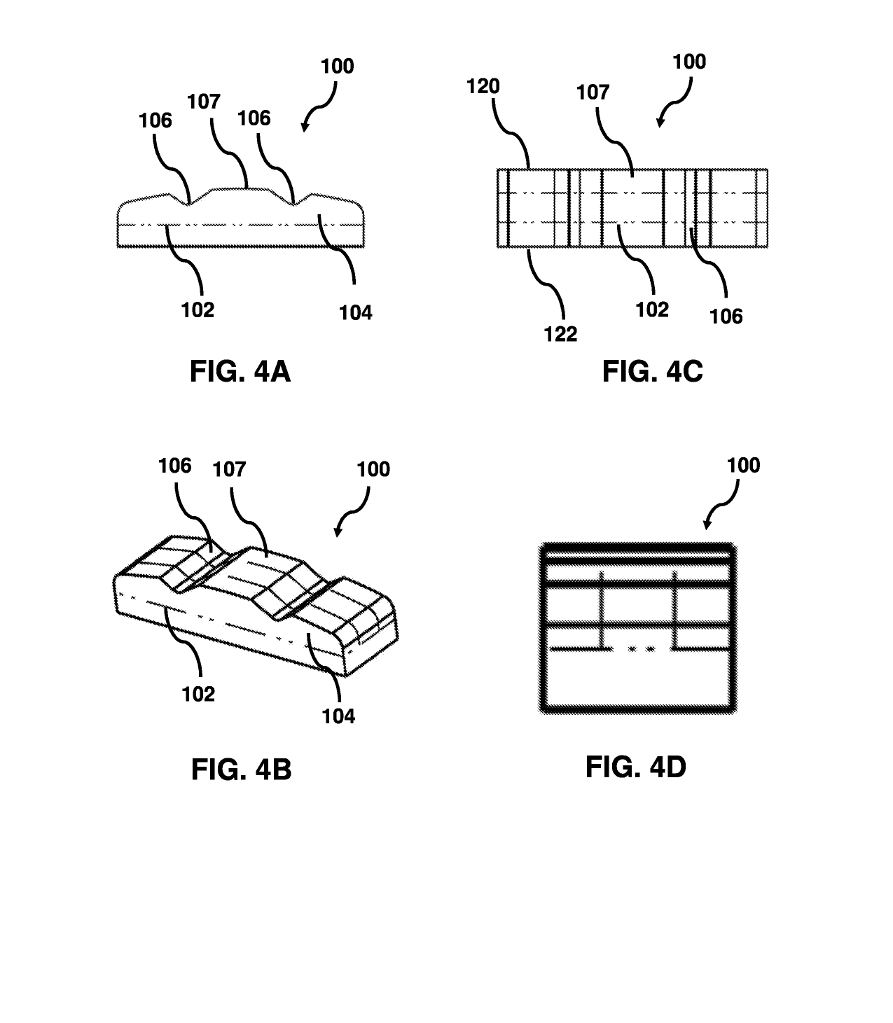

FIGS. 4A-4D depict cutting segment 100. In some embodiments, diamond crystals can be embedded in the metal bonding matrix by sintering. Sintered cutting segment 100 comprises diamond crystals 102 and bonding matrix 104. In some embodiments, bonding matrix 104 can be metal. Metals used in bonding matrix can include, but are not limited to, cobalt, iron, tungsten, carbide and/or copper. The composition of the metal bonding matrix, the concentration of diamond crystals and the diamond size can be adjusted in different embodiments based on the target cutting medium. In some embodiments, cutting segment 100 can comprise multiple lateral layers of bonding matrix 104 with varying concentrations of diamond crystals 102. In some embodiments, cutting segment 100 can comprise lateral gradient layers of bonding matrix 104 with increasing or decreasing concentrations of diamond crystals 102. In some embodiments, cutting segment 100 is defined as a singular, continuous concentration of diamond crystals 102 embedded in bonding matrix 104. In some embodiments, the outermost layer of cutting segment 100 can have a different concentration of diamond crystals than the inner layers.

In some embodiments, the cutting segment can contain synthetic diamond crystals to maintain structural integrity and prevent fracturing for longer periods at higher temperatures. This is particularly useful for dry cutting as this process generates more heat.

In some embodiments, other abrasive or synthetic abrasive cutting elements can be used in the cutting segment such as synthetic diamond or cubic boron nitride.

In some embodiments, cutting segments can contain a combination of diamond crystals, synthetic diamond crystals and/or other abrasive cutting materials.

Top surface 107 of cutting segment 100 can have surface notch(es) 106 to decrease the surface area of cutting segment 100 that is exposed to target material to be cut. Decreased surface area of the cutting segment is advantageous as it reduces the amount of power required for cutting through a given material when utility chain 10 is utilized in a chainsaw. In some embodiments, as shown in FIGS. 4A-4D, top surface 107 of cutting segment 100 can have two surface notches 106. In some embodiments, cutting segment 100 can have more than two surface notches. In some embodiments, top surface 107 of cutting segment 100 lacks surface notches.

In some embodiments, top surface 107 can be grooved, serrated, scored, toothed, crosshatched or otherwise indented to decrease the surface area of cutting segment 100.

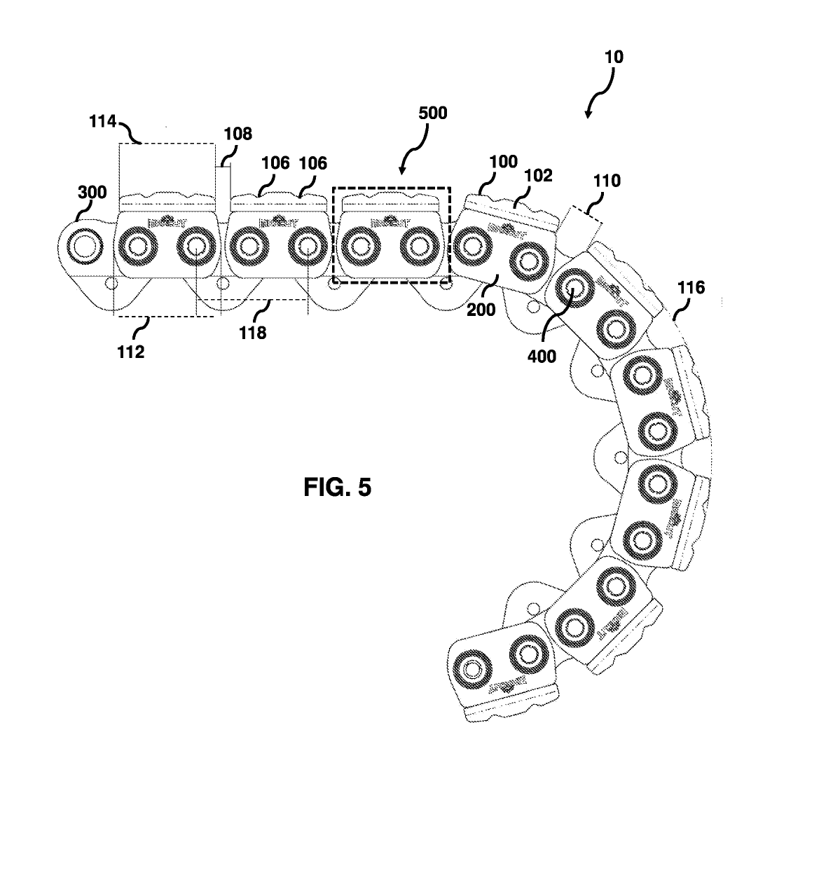

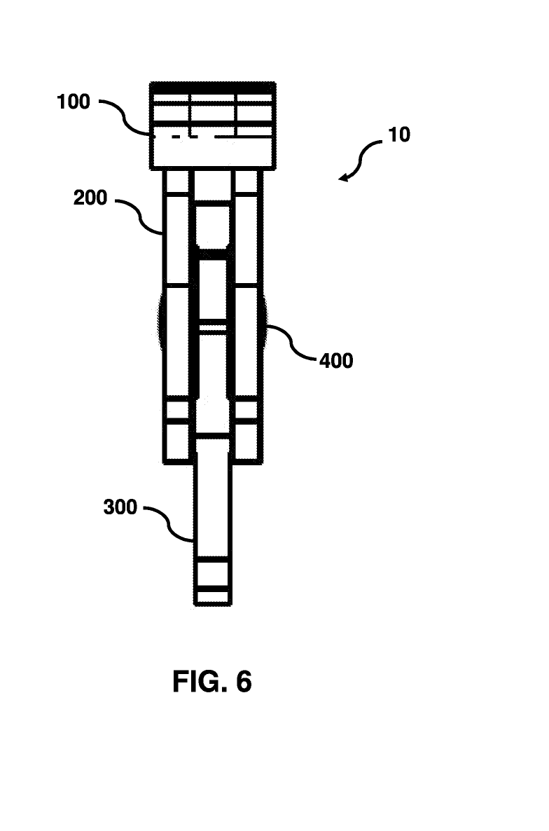

Turning to the assembly of utility chain 10, as illustrated in FIGS. 5 and 6, each cutting segment 100 can be attached to two side plates 200 by laser welding to create cutting link 500. In some embodiments, upper surface 206 of side plate 200 can be essentially flat to provide maximum surface area for attachment of cutting segment 100. This improves the stability and durability of cutting link 500. In the embodiment shown in FIG. 1, utility chain 10 is assembled by each opening 301 of drive link 300 aligning with opening 203 of side plate 200 and securing with rivet 400. In some embodiments, every side plate 200 is attached to a cutting segment 100. A chain consisting of repeating cutting links can be formed by securing drive link 300 and cutting link 500 with rivets 400 in a repeating fashion.

When utility chain 10 utilizes repeating cutting links 500, closed gap 108 is defined by the area between neighboring cutting segments. In some embodiments, when utility chain 10 is used in a chainsaw, closed gap 108 expands to open gap 110 when utility chain 10 travels from the elongated portion of the guide bar (not shown) to curve around the sprocket (not shown).

In some embodiments, side plate 200 can have side plate length 112 and cutting segment 100 can have cutting segment length 114. Note, cutting segment length 114 dictates the cutting segment length of cutting link 500. In some embodiments, cutting segment length 114 can cover the entire upper surface 206 of side plate 200. This configuration reduces the length of closed gap 108 and open gap 110. During use, reduction in open gap 110 serves to minimize, or at least reduce, the impact between cutting link 500 and the material being cut. Cutting arc 116 is defined by the trajectory of top surface 107 of cutting segment 100 as utility chain 10 moves around the sprocket.

In some embodiments, side plate 200 can include a grove and/or a ring around opening 203. In some embodiments, side plate 200 is flush around opening 203.

In some embodiments, cutting segment length 114 does not span the entirety of upper surface 206 of side plate 200.

The pitch of utility chain 10 is defined by link length 118 divided by two. In some embodiments, the length of utility chain 10 can vary to accommodate different sizes of guide bar.

In some embodiments, utility chain 10 can be configured to cut through materials such as, but not limited to, ductile iron pipe, cast iron pipe, PVC pipe, high-density polyethylene pipe and/or other commonly used pipe materials. In these embodiments, depicted cutting segment 100 is attached to two side plates 200 by laser welding to create cutting link 500. In some embodiments, utility chain 10 comprises repeating cutting links 500 secured to drive links 300 without the use of bumper segments or non-cutting side plates. In some embodiments, drive links 300 and cutting links 500 are secured with rivets 400.

In some embodiments, drive link 300 can include a grove and/or a ring around opening 301. In some embodiments, drive link 300 is flush around opening 301.

In pipe-cutting embodiments of utility chain 10, cutting link 500 can utilize a sintered cutting segment. Unlike brazed cutting segments which contain a single surface layer of diamond crystals, a sintered cutting segment creates multiple layers of diamond crystals. As the bonding matrix of the sintered cutting segment erodes with use, damaged or fractured diamond crystals fall out exposing new diamonds for cutting. This effectively extends the life of the cutting link and the overall utility chain.

In some embodiments, such as when utility chain 10 is utilized to cut pipe, diamond crystals 102 of the sintered cutting segment can have a grit size of 25-45 mesh. In some embodiments, the concentration of diamond crystals in the outermost layer of the sintered cutting segment is different from the concentration of diamond crystals in the inner layers of the sintered cutting segment. In some embodiments, the outermost layer of the sintered cutting segment can have a diamond crystal concentration range between and inclusive of 18-22 CON in the bonding matrix. CON is unit a measurement used in the blade industry in which 100 CON equals 72 carats of diamond per cubic inch of segment. Lower numbers indicate a lower concentration of diamonds per cubic inch. In some preferred embodiments, the outermost layer of the sintered cutting segment can have a diamond crystal concentration of 20 CON. In some embodiments, the inner layers of the sintered cutting segment can have a diamond crystal concentration range between and inclusive of 10-14 CON in the bonding matrix. In some preferred embodiments, the inner layers of the sintered cutting segment can have a diamond crystal concentration of 12 CON.

Increasing the concentration of diamond crystals on the outermost layer of the sintered cutting segment helps maintain the width of the cutting segment for a longer period of time. Additionally, the difference in the diamond crystal concentration between the outermost layer and the inner layers of the sintered cutting segment allows for controlled erosion of the bonding matrix to occur faster in the central portion of the cutting segment while reducing the rate of erosion on the edges of the cutting segment which prevents, or at least reduces, rounding of the cutting segment. The advantage of reduced rounding is that as the cutting segment rounds, the surface area of exposed diamond crystal is increased, and more power is required to cut through a given material.

In some embodiments, link length 118 can have a range between and inclusive of 0.912 inch-0.924 inch (2.32 cm-2.35 cm). In some preferred embodiments, link length 118 can be 0.912 inch (2.32 cm). The resulting pitch of utility chain 10, dictated by link length 118, can have a range between and inclusive of 0.456 inch-0.462 inch (1.16 cm-1.17 cm). In some preferred embodiments, the pitch can be 0.456 inch (1.16 cm).

In some embodiments, segment length 114 of cutting link 500 or cutting segment 100 can have a range between and inclusive of 0.781 inch-0.793 inch (1.98 cm-2.01 cm). In some preferred embodiments, segment length 114 can be 0.787 inch (2.00 cm). In some embodiments, the vertex of surface notch 106 of cutting segment 100 can have an angle of 120°. The distance between the vertex angle associated with each surface notch 106 can be 0.339 inch (0.86 cm). The distance from the bottom of the vertex angle of each surface notch 106 to the bottom of cutting segment 100 can be 0.099 inch (0.25 cm). The distance from the tallest point of the top surface 107 of cutting segment 100 to the bottom of cutting segment 100 can be 0.142 inch (0.36 cm). In some embodiments, the height of the diamond layers, as measured from the tallest point of top surface 107 of cutting segment 100 can be 0.079 inch (0.20 cm). The width of cutting segment 100, defined as the distance from surface 120 to surface 122 (FIG. 4C), can be 0.228 inch (0.58 cm).

In some embodiments, the length of closed gap 108 can have a range between and inclusive of 0.119 inch-0.139 inch (0.30 cm-0.35 cm). In some preferred embodiments, closed gap 108 can be 0.125 inch (0.32 cm). In these embodiments, the gap size defined as the length of closed gap 108 relative to link length 118 can be 13%-15%, preferably 14%.

In some embodiments, the aspect ratio, defined as the ratio of the height of side plate 200 relative to the distance between the rivet holes of side plate 200 can be 1.15 inch (2.92 cm). In some embodiments, the distance from upper surface 206 of side plate 200 to the top surface of drive link 300 is 0.066 inch (0.17 cm).

In some embodiments, the dimensions of side plates, drive links, and cutting segments can be comparably scaled down to create a utility chain with a smaller pitch. In these embodiments, the resulting measurements for the length of the open gap, the length of the closed gap, the cutting arc, the length of the closed gap relative to the link length, and the aspect ratio are altered accordingly.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A utility chain for cutting ductile materials comprising:
(a) a plurality of cutting links, each of said cutting links comprising
(i) a layered cutting segment comprising a plurality of abrading particles embedded in a bonding matrix;
(ii) a first side plate; and
(iii) a second side plate;
(b) a plurality of drive links, each of said drive links connected to a cutting link;
(c) a plurality of connectors, each of said connectors maintaining the attachment of a cutting link to a drive link;
(d) a closed gap length wherein said closed gap length is the distance between a front end of a first layered cutting segment and a back end of a second layered cutting segment.

2. The utility chain of claim 1, wherein each of said layered cutting segments is layered by sintering.

3. The utility chain of claim 1, wherein the concentration of said plurality of abrading particles in an outer layer of each of said layered cutting segments is greater than the concentration of said plurality of abrading particles in an inner layer of each of said layered cutting segments.

4. The utility chain of claim 1, wherein said plurality of abrading particles comprises diamond crystals.

5. The utility chain of claim 4, wherein the grit size of said diamond crystals is approximately 30-40 mesh.

6. The utility chain of claim 4, wherein the concentration of diamond crystals in an outer layer of each of said layered cutting segments is approximately 20 CON and the concentration of diamond crystals in an inner layer of each of said layered cutting segments is approximately 12 CON by weight.

7. The utility chain of claim 1, wherein each of said layered cutting segments is connected to said first side plate and said second side plate by laser welding.

8. The utility chain of claim 1, wherein each of said plurality of connectors is a rivets.

9. The utility chain of claim 1, wherein the top surface of each of said layered cutting segments comprises a first surface notch and a second surface notch formed therein.

10. The utility chain of claim 9, wherein said first surface notch has a vertex angle of approximately 120°.

11. The utility chain of claim 9, wherein said second surface notch has a vertex angle of approximately 120°.

12. The utility chain of claim 1, wherein each of said layered cutting segments has a length in the range of approximately 0.781 inch-0.793 inch (1.98 cm-2.01 cm).

13. The utility chain of claim 12, wherein said length of each of said layered cutting segments defines a gap length in the range of approximately 0.119 inch-0.139 inch (0.30 cm-0.35 cm).

14. The utility chain of claim 1, wherein each of said plurality of cutting links has a length in the range of approximately 0.912 inch-0.924 inch (2.32 cm-2.35 cm).

15. The utility chain of claim 14, wherein the pitch of said utility chain is in the range of 0.456 inch-0.462 inch (1.16 cm-1.17 cm).

16. The utility chain of claim 3, wherein said inner layer comprises a plurality of inner layers.

17. The utility chain of claim 6, wherein said inner layer comprises a plurality of inner layers.

18. The utility chain of claim 1, wherein said closed gap length is less than 0.35 cm.
